(19) United States
(12) Patent Application Publication
(10) Pub. No.: US 2003/0144907 A1
(43) Pub. Date: Jul. 31, 2003

(54) System and method for administering incentive offers

(75) Inventors: Jerome A. Cohen JR., Phoenix, AZ (US); Shashikant A. Rao, Phoenix, AZ (US); Corbett Bloom, Scottsdale, AZ (US); Laxmikant Dash, Phoenix, AZ (US); Simran K. Kalra, New York, NY (US); Aric L. Allen, New York, NY (US); Kimberlee M. Lucas, New York, NY (US); William A. DeSimone, Mahwah, NJ (US); Paige L. Bridges, Brooklyn, NY (US)

Correspondence Address: Snell & Wilmer, LLP, Suite 1900, 1200 Seventeenth Street, Denver, CO, 80202, US

(73) Assignee: American Express Travel Related Services Company, Inc.

(21) Appl. No.: 10/356,895

(22) Filed: Feb. 3, 2003

Related U.S. Application Data
(63) Continuation-in-part of application No. 10/091,612, filed on Mar. 5, 2002.
(60) Provisional application No. 60/273,356, filed on Mar. 5, 2001.

(51) Int. Cl. G06F 17/60

(52) U.S. Cl. 705/14

(57) ABSTRACT

The present invention is directed toward a system and method for administering incentive offers. A system for administering incentive offers includes a centralized repository for storing offer information, a maintenance engine for updating and maintaining the offer information in the repository, and a retrieval engine for finding and retrieving offers. The system cooperates with an offer presentation engine for configuring and presenting offers based on offeree traits and the environment in which the offer is to be presented. An exemplary system formulates tests to determine effects of changes in content or context, tracks events related to presentation and acceptance of offers, evaluates impact of offer changes on offer effectiveness, and predicts optimum offer content and context based on results of such tests.

### CROSS REFERENCE TO RELATED APPLICATIONS

This application claims benefit from U.S. patent application Ser. No. 10/091,612, filed Mar. 5, 2002, which is hereby incorporated by reference, and which claims benefit from U.S. Provisional Patent Application Serial No. 60/273,356, filed Mar. 5, 2001, which is also hereby incorporated by reference.

### FIELD OF INVENTION

The present invention relates generally to systems for facilitating the administration of incentive offerings, and more specifically, to systems for facilitating the effective management of the formulation, storage, presentation, tracking and/or evaluation of offers for presentation to targeted consumers for the purpose of encouraging a desired set of one or more behaviors.

### BACKGROUND OF THE INVENTION

Institutions often communicate specialized incentives and other promotional offers to targets (e.g., existing and potential customers) for the purpose of encouraging those targets to behave in a desired way. For example, a financial services company may communicate an offer for credit services to a targeted consumer (e.g., a prospective cardmember), such an offer including terms such as a specified annual fee, credit limit, and interest rate. Alternatively, the financial services company may communicate offers to various targets (e.g., existing customers) attempting to encourage the use of online services such as statement viewing and payment execution. The financial services company may present such offers via printed mailings, interactive television displays and/or pages transmitted using the internet and viewed using a browser (i.e., web pages). Similarly, merchants engaged in the business of renting video recordings may offer specific video rentals to targeted consumers and may choose the targets to whom to present such offers based on other behaviors such as, for example, purchasing a videocassette player, answering a survey, or demonstrating any other attribute associated with an increased likelihood of renting the offered video.

In general, offers comprise content (i.e., terms) and context (i.e., presentation attributes). The terms of an offer typically have a direct impact upon the value of an offer. The context of an offer, while not affecting value, typically affects the likelihood that a particular offer will be accepted (i.e., converted). For example, exemplary offer terms may include the identity of the subject matter, a quantity, a price and/or fee (e.g., annual fee, interest rate, credit/finance limit, and the like). Exemplary presentation attributes, on the other hand, include timing and/or placement of an offer (e.g., when and/or where to present an offer) as well as details of the presentation (e.g., text, font, color, size, graphics, banners, trademarks, trade dress, look, feel, sound, video, path to offer, and the like).

In addition to variables in the content and context of offers, it is understood that targets also carry a wide array of attributes. For example, targets may bear varying attributes such as gender, age, education, income, credit score, credit saturation, trading history, previous exposure (i.e., experience), and the like. Nevertheless, as the pool of targets increases, it becomes possible to classify groups of targets according to their demographic characteristics. While selection of classification criteria may be performed in many ways, it may be preferable to form such classes of targets based on the likelihood of each class' members responding to a specific set of circumstances in a similar manner. For example, male college students between the ages of 18 and 20 may be grouped due to their increased likelihood of responding to some specific offers or types of offers relative to other specific offers or types of offers.

A wide variety of mechanisms are used by offerors to communicate specific offers to offerees or groups of offerees. For example, an offeror may present an off-line offer through telemarketing, direct mail, publications, advertising in the media, or communications at a point of sale. In addition, an offeror may present an on-line offer while interacting with an offeree through a computer network such as the internet.

In addition, the context of offer presentations may be varied according to location. For example, an offer for a video rental may be presented at a video rental store location (e.g., via a terminal or a large display advertisement such as a sign), at the target's home (e.g., via the internet or through an advertisement appearing on television, in a periodical or even a direct mailing), or at another merchant (e.g., presented to a target as the target purchases popcorn or a VCR). In addition, the context of offer presentations may be varied according to presentation time (e.g., the relative time within the chronology of a shopping trip, the time of the day, the day of the week or of the month, the month or season of the year, and the like). For example, offers for extending credit may be timed to precede the end of a pay period or a traditional spending period such as the year end holidays or summer vacations. Offers for purchase of impulse items may be timed to leave little time for abandonment. Offers for exercise equipment may be presented to take advantage of new year's resolutions.

Where offers are presented via the internet, one or more offers may be presented on a web page. Some presenters may be engaged in very specific campaigns aimed at targeting a very specific demographic segment (e.g., selling starter homes in a small local market). Such presenters may structure a single campaign (e.g., tailored to offer properties from that community and providing information about that community to targets interested in buying real estate there). Where such a discrete campaign is to be presented via a web site (i.e., by accessing a single internet address or set of internet addresses), the web site may be configured to contain relatively few main pages one or more subpages for individually tailored offers.

Other presenters may choose to formulate and present several campaigns, each aimed at targeting a different need for each of several demographic segments (e.g., selling a full array of financial services tailored to the specific needs of several diverse demographic groups). Such presenters may structure several campaigns each tailored to specific needs and each adaptable to separate segments of the target demographic. Where such a diverse set of campaigns is to be presented via one or more web sites, the web sites may be configured to contain several web pages and subpages to simplify navigation and maximize offer effectiveness. In such cases, a single offer may be presented in conjunction with several different campaigns (e.g., on the different web pages) depending upon the goals of the campaigns. Accordingly, campaigns may be configured to cross-sell offers from one or more other campaigns.

Often, a correlation may be drawn between consumers engaged on a first activity (e.g., purchasing a VCR, purchasing a new car) and the likelihood of that consumer to accept a related offer (e.g., for the rental of a video recording, for the purchase of popcorn, to obtain financing). Where such a correlation may be drawn, offerors frequently engage in cross-selling. Cross-selling may occur within a particular merchant such as where an offer for the purchase of socks is presented to a target engaged in the purchase of shoes. Cross-selling may also occur between distinct merchants or service providers such as where an automobile salesman suggests a particular provider of financial services. In the case of offers presented via the internet, a presenter of a first offer for a first set of services via a first web page (e.g., a presentation of an offer to provide a free toaster if a target opens a checking account) may engage in cross-selling by also presenting an offer for a second set of services (e.g., crediting the target with frequent flier miles if the target accepts a credit card) via the same first web page.

In general, offers usually include a means through which an offeror may provide an incentive to an offeree such that if a predetermined condition is satisfied, the offeree may enjoy the benefits associated with the incentive. While this general definition of an offer may be relatively simple, in practice, there are many variables which may be combined to render a nearly limitless array of specific offers. Thus, although the content of the offers may vary widely, the basic characteristics of offers remain fairly consistent.

For example, the incentives embodied in a specific offer may be tangible or intangible in nature. If the incentive is a tangible object, the offer may be structured so that the offeree may receive possession of the object. If the incentive is intangible, such as a right to receive a discount, to use information, or to enjoy some other benefit, the offer may be structured so that the offeree will be entitled to enjoy that intangible incentive.

In addition to the nature of the incentive, offers may vary in the form of their predetermined conditions. For example, an offeror may wish to condition the incentive upon the purchase or use of a specific good or service. Alternatively, the offeror may tie the incentive to an action taken at a specific merchant or service provider. Further, an offeror may wish to provide an incentive to encourage one or more behaviors such as checking statements and/or making payments online, making consistent timely payments, demonstrating loyalty to a particular merchant, maintaining a specified minimum or maximum monthly balance in an account, or transacting a desired quantity of business using a specified charge or credit card. While these predetermined conditions may vary widely, they consistently involve a definition of who (e.g., the target consumer) should perform what act (e.g., use or agree to purchase specific goods or services) within what time period (e.g., during the offer period) and at what location (e.g., at a specified merchant).

In some cases, it is a single specific entity within a company, such as the marketing organization, that is responsible for managing the definition, communication, and administration of offers. Although such organizations may delegate some or all of the tasks relating to managing offers, they may still retain significant controls. It has been found that such centralized management of offers enables coordination between the participants in the process and adequate control over the creation and presentation of offers, which can contribute to consistency between communicated offers, enhancing the effectiveness of those offers in modifying offeree behavior.

In other organizations, particularly in large, geographically diverse organizations, it is often the case that no single entity is responsible for all aspects of managing the definition, communication, and administration of offers. As a result, the same or similar offers may be created multiple times by multiple organizations or business units, with different, and often conflicting or competing, objectives in mind. Wherever little or no centralized body exists to manage offers, there frequently will be little or no coordination or control governing their creation and presentation. Consequently, inconsistent offers may be presented, causing offeree experiences that may be unbalanced, inconsistent and confusing. As a result, the incentive programs may be counterproductive and may be unable to achieve their desired objectives.

The recent growth in on-line commerce, in which many large organizations now participate, has partially ameliorated these shortcomings. In the on-line environment, organizations are able to speak with a single voice, regardless of the geographic diversity of the organization. As a result, on-line commerce offers new opportunities to avoid inconsistencies in the presentation of offers. For example, the opportunity now exists to collectively manage offers from multiple diverse merchants as well as offers from discrete large entities.

At the same time, however, it is not always preferable to provide only a single offer to all offerees in all situations. Whether offers are to be collected and centrally managed for a single, large organization or for many small, diverse merchants, consideration may be given to the regulatory, environmental, taxation, competitive, and environmental variations that exist throughout the global marketplace. The incentives used to encourage offerees to behave in a desired manner may also depend upon income level, gender, past behavior, and/or other offeree traits. They may also depend upon the geographic location, the current economic climate, laws and regulations, or seasonal variations in the marketplace. Under a system of distributed discretion, individuals within the system may be better able to tailor specific offers to specific targets (i.e., offerees) and specific situations, enhancing the effectiveness of each presented offer. Accordingly, while a centralized offer management infrastructure may facilitate consistency between offers, such an infrastructure may be ineffective if it fails to effectively accommodate variations in the traits of its intended offerees and the environment in which offers are to be presented. The centralized management of offers may actually be counterproductive if the system is unable to accommodate the wide array of variables that exist in the marketplace.

Accordingly, it would be beneficial to have a system and method for providing centralized management of offers while enabling offers to be customized for specific offerees and situations.

As briefly mentioned above, it is well understood that to maximize the effectiveness of one or more offers, it may be desired to vary both the content (terms) and the context (presentation) of those offers. As the terms of offers are varied, it is useful to determine and track the value of the offers (e.g., the value to the offeror, the value to the offeree). One mechanism for tracking such value is to determine each offer's net present value (NPV). For example, where a particular offer may be expected to generate a future profit to the offeror, if and when the offer is accepted and fully performed, that future profit may be discounted based on the time value of money and any risks (e.g., non-performance). In this way, the anticipated profit may be normalized to produce an NPV, and varied offers may be compared on the basis of their NPVs. It should be noted that each NPV likely depends upon the content of the offer and may also depend upon the characteristics of the target, such as the offeree's creditworthiness.

In addition to determining values of individual offers or sets of offers, i.e., offer campaigns, it may be useful to assess the likelihood that particular offers or offer campaigns will lead to acceptance and/or complete performance. It should be noted that with respect to each offer or set of offers, the likelihood of acceptance may depend upon both content and context. For example, as offers are presented with terms that are increasingly valuable to the target, the likelihood that those offers will be accepted increases. At the same time, however, it is likely the NPVs of those offers to the offeror are decreasing. Similarly, as offers are presented in contexts that are increasingly appealing to the target, the likelihood that those offers will be accepted may increase—even though those changes in context may not have any impact on each offer's NPV. Accordingly, it may be useful to accommodate variations in both the content and context of offers by assessing a probability-discounted NPV based on the product of the likelihood of acceptance and the NPV of each offer as presented. It should be noted that such a probability-discounted NPV would likely depend upon both the content and context of each offer as presented.

Unfortunately, current offer management systems typically include labor-intensive processing to set up individual offers and sets of offers (i.e., campaigns). Moreover, current systems do not provide for sufficient automated adaptation of offers and/or campaigns based on what is and/or is not effective. Current systems are not sufficiently capable of automatically personalizing content (i.e., determine the best content and context in which to communicate an offer to a target) while maintaining an acceptable level of control over the presentation attributes of offers (e.g., maintaining a consistent look and feel).

In addition, no adequate offer-management system exists that can efficiently facilitate reliable testing of individual offers or campaigns (e.g., testing of effectiveness of offers in differing contexts or to differing targets). Past attempts to create tests have often required a labor intensive process to set up campaigns and offers and have been unable to make changes without affecting entire online cross-sell initiatives. Further, current systems do not provide adequate control groups. Accordingly, it is unreasonably difficult, if not impossible, to use existing systems or methods to determine the effects of variations in offer content and context of offer effectiveness.

Another problem with current offer management systems is that they are unable to provide satisfactory attribution when particular offers are accepted or additional information is requested and/or provided. For example, in many situations, management systems are only able to attribute the acceptance of an offer back to the originator of the offer. Accordingly, unless a particular presenter or campaign had originated the offer, that presenter or campaign was not credited for achieving an acceptance of the offer. Other management systems may only be able to attribute the acceptance of an offer back to the presenter of the offer or its associated campaign. In accordance with these systems, allocation of credit for achieving an acceptance of an offer may be impossible. For example, where different parts of a website may provide the same offer, current systems may credit conversion to the campaign that originally provided the offer. In other systems, conversion may only be credited to the login page package.

Accordingly, it would be advantageous to be able to track: (1) both the content and context of presented offers; (2) which offers are converted (accepted by the target); and (3) demographic attributes of targets. It would also be advantageous to be able to analyze effects of changes in the content and context of offers on the value of an offer to the offeror, the likelihood that the offer will be accepted, and the probability-discounted value of those offers. It would further be advantageous to be able to differentiate results of such analyses based on the known attributes of targets (e.g., different sets of results for different target types). It would further be advantageous to be able to determine the optimum combination of content and/or context for a particular offer based on the combined sensitivities to changes in content and/or context.

It would also be advantageous to be able to adapt the content and/or context of an offer in order to improve (e.g., maximize) the value of offers to the offeror, the likelihood that such offers will be accepted, and the probability-discounted values of such offers for identified sets of target consumers. It would also be advantageous to be able to personalize content based on customer product ownership and behavior. Finally, it would be advantageous to be able to formulate tests for the purpose of determining sensitivities of offer value, acceptance likelihood, and discounted value to changes in offer content and context.

### SUMMARY OF THE INVENTION

The present invention is directed toward a system and method for facilitating the effective management of incentive offers. In particular, the invention is directed toward a system and method for facilitating the effective management of the formulation, testing, storage, tracking and evaluation of offers for presentation to targeted consumers for the purpose of encouraging a desired set of one or more behaviors. A system for administering incentive offers includes a centralized repository for storing offers, a maintenance engine for updating and maintaining the offers in the repository, and a retrieval engine for finding and retrieving offers. The system cooperates with an offer presentation engine for configuring and presenting offers based on offeree traits and the context in which the offer is to be presented. Each offer includes a set of desired terms (i.e., content) and may be presented in a prescribed manner (i.e. according to a prescribed context). In addition, each offer may comprise both an offer summary and offer details. In an exemplary embodiment, a system for administering incentive offers also includes an offer formulator. Other exemplary systems may include an event tracker and/or an offer evaluator.

A centralized repository is configured to store an offer summary and a set of offer details for each stored offer. In general, offer details include who (e.g., the target consumer) performs what act (e.g., use or agree to purchase specific goods or services) within what time (e.g., during the offer period) and at what location (e.g., at a specified merchant) in order to receive what incentive. In addition, a centralized repository may also store offer contents, offer contexts, target attributes and tracked acceptance data regarding offer effectiveness.

A maintenance engine is adapted to respond to requests to create, modify, and delete offer summaries and offer details stored within the centralized offer repository. A maintenance engine also includes a security mechanism adapted to authenticate a user before granting the user access to the repository. In accordance with an exemplary embodiment, a security mechanism is configured to limit access to a specific user or group of users, thereby enabling a maintenance engine to safeguard the confidentiality of data within the repository and to prevent data from being disclosed in any unauthorized or undesirable manner.

A retrieval engine includes both a search tool and a retrieval tool and is configured to cooperate with an offer presentation engine for configuring and presenting offers. Accordingly, a retrieval engine is adapted to send a request to the search tool for the identification of an offer or set of offers. The search tool is configured to identify conforming offers, and the retrieval tool is configured to retrieve the identified offer or set of offers. Finally, the system is configured to facilitate the configuring and presenting of an offer to an offeree by the offer presentation engine. Accordingly, offer presentation engine may present indicated offer content in accordance with prescribed offer context as indicated by an offer formulator.

In accordance with an exemplary embodiment, an exemplary offer formulator may include an information retriever and an offer adaptor. An exemplary information retriever facilitates acquiring identity information regarding a target and accessing a centralized repository to obtain further data about the user (e.g., target's attributes, customer product ownership, behavioral history). In addition, information retriever retrieves offer content and context information from centralized repository.

Offer adaptor is configured to adapt the content and/or context of specific offers in order to improve the effectiveness of the offer, which may be predicted according to a probability-discounted NPV. Accordingly, the adaptor is configured to consider the specific set of attributes of the target and to predict an optimum combination of offer content and context based on the predicted aggregate effect of the content and context on the probability-discounted NPV. Predictions regarding the aggregate effects of multiple changes may be generated through methods such as root mean square, Bayesian modeling, and/or Monte Carlo simulation techniques. In addition, offer adapter may be configured to formulate tests for the purpose of generating data (e.g., determining sensitivities) useful in evaluating one or more predetermined levers in specific controlled circumstances.

In an exemplary embodiment, an event tracker is configured to track the content and/or context of presented offers as well as the demographic attributes of targets and the results following offer presentation (e.g., which offers are accepted by the target). In an exemplary embodiment, event tracker is configured to record target responses to presented offers (e.g., offer presentments, offer requests, requests for further information, and offer acceptance) and to accommodate delays between offer presentment and offer acceptance.

Finally, an offer evaluator is configured to determine the actual effects of changes in content of offers on NPV and likelihood of acceptance. Accordingly, offer evaluator is configured to assess the effect of a change in the presentation context of one or more offers on likelihood of acceptance of the offers. In addition, offer evaluator is configured to assess the effects of changes in offer content and/or offer presentment context on probability-discounted NPV. Finally, offer evaluator is configured to correlate results of such assessments to identified target attributes (e.g., to group demographic profiles according to results).

### BRIEF DESCRIPTION OF EXEMPLARY DRAWINGS

The above-mentioned objects and features of the present invention can be more clearly understood from the following detailed description considered in conjunction with the following drawings, in which like numerals represent like elements and in which:

FIG. 1 illustrates an exemplary system for administering incentive offers;

FIG. 2 illustrates an exemplary centralized offer repository;

FIG. 3 illustrates an exemplary process for administering incentive offers; and,

FIG. 4 illustrates an exemplary process for administering incentive offers utilizing an event tracker and offer formulator.

### DETAILED DESCRIPTION OF EXEMPLARY EMBODIMENTS

The present invention includes an incentive offer storage and retrieval vehicle that is configured to allow users to administer incentive offers in a coordinated and consistent manner. The system thereby facilitates the creation, adaptation, testing, evaluation, storage, maintenance, identification, and retrieval, of incentive offers for presentation to offerees for the purpose of encouraging a desired set of one or more behaviors. In accordance with one aspect of the invention, a system for administering incentive offers includes a centralized repository for storing offers, a maintenance engine for updating and maintaining the offers in the repository, and a retrieval engine for finding and retrieving offers.

In an exemplary embodiment, the system may be configured to facilitate the configuring and presenting of an offer to an offeree by an offer presentation engine. Accordingly, the system may cooperate with an offer presentation engine for configuring and presenting offers based on offeree traits and the context in which the offer is to be presented. In an exemplary embodiment, a system for facilitating the administration of incentive offers includes an offer formulator, an event tracker, and an offer evaluator. An exemplary offer formulator may include an information retriever and an offer adaptor.

Each offer includes a set of desired terms (i.e., content) and may be presented in a prescribed manner (i.e. within a prescribed context). In addition, each offer may comprise both an offer summary and offer details. A centralized repository is configured to store an offer summary and a set of offer details for each stored offer. In general, offer details define who (e.g., the target consumer) performs what act (e.g., use or agree to purchase specific goods or services) within what time (e.g., during the offer period) and at what location (e.g., at a specified merchant) in order to receive what incentive. In addition, a centralized repository may also store offer contents, offer contexts, target attributes and tracked acceptance data regarding offer effectiveness.

A maintenance engine is in communication with the centralized repository and is adapted to facilitate the creation, modification, and deletion of offer summaries and offer details stored within the centralized offer repository. I should be noted that as soon as an offer has been added to the repository and approved by the merchant, it may be available to be searched and/or retrieved. A maintenance engine also includes a security mechanism adapted to facilitate the authentication of a user before granting the user access to the repository or otherwise facilitating manipulation of offer data by the user. In accordance with an exemplary embodiment, a security mechanism is configured to limit access to a specific user or group of users, thereby enabling a maintenance engine to safeguard the confidentiality of data within the repository and to prevent or limit data from being disclosed in any unauthorized or undesirable manner.

Further, a retrieval engine is also in communication with the centralized database and includes both a search tool and a retrieval tool. Accordingly, a retrieval engine is adapted to send a request to the search tool for the identification of an offer or set of offers. The search tool is configured to identify conforming offers, and the retrieval tool is configured to retrieve the identified offer or set of offers for communication to an offer presentation engine. In an exemplary embodiment, the search and retrieval instructions may be configured by a user. Thus, in response to a user defined request, which may include definitions of which offer parameters are to be sought and which parameters are to be retrieved, the retrieval engine seeks the desired offers in accordance with the user selected parameters and returns the parameters desired by the user. It should be noted that the user specification of offer parameters to be returned may be expressed as an instruction to return only a specified set of parameters or alternatively may be expressed as an instruction to return at least a specified set of parameters or may be expressed in any other form commonly known in the art.

Accordingly, the retrieval engine is configured to communicate with an offer presentation engine, which facilitates the configuring and presenting of an offer (i.e., content and context) to an offeree. Upon receipt of the requested offer information, an offer presentation engine facilitates the configuring of offers, accommodating variations in the traits of offerees and the contexts in which the offers are to be presented. Accordingly, the system may be configured to accommodate many variables that exist in the marketplace.

In an exemplary embodiment, the system comprises an offer formulator that further includes an information retriever and an offer adapter. In accordance with this embodiment, the information retriever is configured to acquire information regarding the identity of the target (e.g., obtains cookie information from the user computer; obtains the identity of the target via an electronic identifier such as an RF emitter; obtains the target's identity via credit card, debit card, or membership information; or obtains or verifies an identity of the user through biometric means such as fingerprint or iris scan, etc.). It should be noted that in embodiments where the information retriever obtains cookie information from the user computer, means may also be provided for configuring the cookie to uniquely identify the user and for placing the cookie on the computer of the user. In an exemplary embodiment, when a user registers with the system of the invention, such a system may insert a text string containing a global user identifier (i.e., a GUID) within a cookie and facilitate saving the cookie in the memory of the user's computer. Accordingly, whenever the system desires to acquire the identity of the user (e.g., when the user initiates communication with the system or when the user clicks on an offer or submits a request), the information retriever may retrieve the cookie, read the GUID within the cookie, and use the GUID or other identification information. Based on target identity, or other available information, information retriever accesses centralized repository and obtains further data about the target (e.g., target's attributes, targets existing product ownership profile, behavioral history, and the like). It should be noted that such information may be organized according to any convenient means for uniquely identifying a person (e.g., by identification number, name, address, social security number, zip code, or another predefined code number or set of data). In addition, information retriever retrieves offer content and context information from centralized repository.

In an exemplary embodiment, offer adaptor is configured to adapt offers based on specific offer content and/or context information in order to improve the effectiveness of the offer to be presented to the target. For example, in an exemplary embodiment, offer adapter may select a color scheme or other predefined trade dress (e.g., a color scheme, a sports themed motif, a fine-arts motif) based on attributes of the user (age, gender, known preferences, established history). As another example, offer adapter may vary the terms of an offer (e.g., offer sporting event tickets rather than opera tickets, offer reduced interest rate rather than low annual fee, offer frequent flier miles rather than cash rebates). In an exemplary embodiment, the effectiveness of an specific offer is predicted according to a probability-discounted NPV based on the product of the net present value (NPV) of the offer to the offeree, if accepted, and the probability that the target will accept the offer as presented. Accordingly, offer adaptor is configured to consider and accommodate the specific set of attributes of the target and to predict an optimum offer content and context based on the aggregate effect of the content and context on the probability-discounted NPV. In an exemplary embodiment, such aggregate effects are predicted using root mean square methodologies, Bayesian modeling, and/or or Monte Carlo simulation techniques. Accordingly, the step of personalizing content may include determining an optimum combination of content and/or context based on combined sensitivities to changes in content and/or context (e.g., based on probability discounted NPV considering target attributes). Thus, the offer adaptor is configured to facilitate optimization of probability-discounted NPV. It should be noted, however, that a variety of mechanisms may be devised for evaluating an optimum offer. For example, offers may be evaluated based on the interest they generate, which could, in turn, be measured by their anticipated or actual click rates (i.e., the rates at which offerees tend to respond either by requesting further information or by accepting specific offers).

In accordance with an exemplary embodiment, an offer is communicated to a target after the card member connects to a website. The offer adapter predicts which offer content and context will be most effective to display on the website based on cookie information about who the card member is and additional information acquired about the card member. As discussed above, the cookie contains information for identifying the user such as a global user identifier or a name or an address or any other information useful for identifying the user. In an exemplary embodiment, the system included means for configuring the cookie and placing it on the user's computer.

In addition, offer adapter may be configured to formulate tests for the purpose of determining sensitivities of offer values and/or acceptance probabilities to changes in offer content and context. In an exemplary embodiment, offer adapter is configured to formulate such tests with provisions for appropriate controls, normalization of results, generating appropriate sample sizes, and considering statistical significance of the generated results. Exemplary tests may be configured to generate dates useful in evaluating one or more predetermined factors under specific controlled circumstances. Further, offer adapter may be configured to detect the occurrence of specific circumstances such as prevailing interest rates or other economic indicators, to present modified offers, to track results such as levels of interest (i.e. click rates), and to evaluate effectiveness of modifications to presented offers. Exemplary factors to be considered may include customer segment (i.e., target attributes), product set (i.e., terms, content), page type (i.e., context), and creative strategy (i.e., context). Accordingly, offer adapter may be configured to facilitate executing appropriate tests to identify a correlation between the factors and probability-discounted NPV.

In an exemplary embodiment, an event tracker is configured to track both the content and context of presented offers as well as the demographic attributes of targets and the results following offer presentation (e.g., which offers are accepted by the target). In an exemplary embodiment, event tracker is configured to record target responses to presented offers (e.g., offer presentments, offer requests, requests for further information, and offer acceptance) and to accommodate delays (e.g., up to 30 days) between offer presentment and offer acceptance. Such tracking may be tied to one or more product code, time data, path, or other context information associated with an offer or campaign of offers. For example, time data may comprise the timing and/or order of offer-related events such as presentation, conversion, acceptance, or a request for one or more offers or other sets of information. Path data may comprise an internet address associated with the information and/or offers presented to the target, and may also comprise the physical location (e.g. store location, IP address) of the information/offer provider and/or presenter and/or the target. Product code may be any code or other indicia configured to identify any pertinent aspects of the content and/or context of the presented offer or information.

Accordingly, event tracker may be configured to facilitate the association of offer conversions to specific offers presentations and/or other associated events (e.g. clicked events). In accordance with an exemplary embodiment, after a target accepts an offer, an appreciation page may be presented to the target while data regarding the conversion is sent to centralized repository. Further, centralized repository may add a marker to indicate if the conversion is active or passive, and records may be generated based upon both active and passive conversions.

In an exemplary embodiment, an offer evaluator is configured to determine the actual effects of changes in content of offers on NPV and likelihood of acceptance. Accordingly, offer evaluator is configured to assess the effect of a change in the presentation context of an offer on likelihood of acceptance of the offer. In addition, offer evaluator is configured to assess the effects of changes in offer content and/or offer presentment context on probability-discounted NPV. Finally, offer evaluator is configured to correlate results of such assessments to identified target attributes (e.g., to group demographic profiles according to results).

In accordance with a further aspect of the present invention, a method of administering an incentive offer storage and retrieval vehicle is also provided. In accordance with the invention, an administrator may receive a request from a user to create, modify or delete an offer or a portion of an offer. In response, the administrator causes the maintenance engine to perform a database maintenance process. In an exemplary embodiment of the database maintenance process, the maintenance engine causes a security mechanism to authenticate the user, e.g., determining whether the user is authorized to initiate the action or whether the action is desirable to the system in accordance with a predetermined set of rules (i.e., that offer data be modified only by the offering merchant, that offer data be retrievable by anyone, that specific search queries be accessed by only authorized members). If the security mechanism authenticates the user and approves the desired action, the maintenance engine accommodates the user's request and modifies the offer data accordingly. In this way, the maintenance engine facilitates the maintenance of the centralized repository of offer data.

In accordance with the invention, the administrator may also receive a request from a user seeking to find offers bearing specified characteristics (e.g., offers for a specified service to be performed in a specified location or by a specified service provider, offers pertaining to a specific product, a particular offer identified by a reference code or SKU information). In response to the user's request, the administrator initiates an action by the retrieval engine, which responds by activating its search tool to identify offers bearing the desired characteristics. Once the search tool has identified the conforming offers, the retrieval engine activates its retrieval tool, which retrieves the conforming offer data.

Upon receipt of the offer data from the retrieval tool, the retrieval engine is configured to facilitate the configuring and presenting of an offer to an offeree by an offer presentation engine, which is in communication with the retrieval tool. The presentation engine facilitates the configuring of offers based on the traits of offerees and the contexts in which the offer is to be presented to the offerees. For example, if a particular offeree has demonstrated a certain level of creditworthiness, the presentation engine may configure an offer for a credit card to have a lowered interest rate in accordance with a set of rules accompanying the offer details. As a further example, the presentation engine may configure an offer for a discount on the purchase of a perishable item with the discount being based on the date of the offer relative to the expiration date of the available stock of the item or the quantity of the item remaining. Accordingly, the presentation engine may configure an offer for presentation to an offeree based on the traits of the offeree and the context in which the offer is to be presented. As such, the presentation engine may be configured to create, adapt and/or modify the offers in accordance with a predetermined set of rules as well as other data regarding either the offeree or the contextual environment of the offer. Accordingly, the offer as presented by the retrieval engine may not include all of the information in the offer details, but instead, may represent a customized presentation adapted to the particular offeree or the particular situation. Thus, in accordance with the present invention, the system may encourage targets, e.g., customers, to accept more offers.

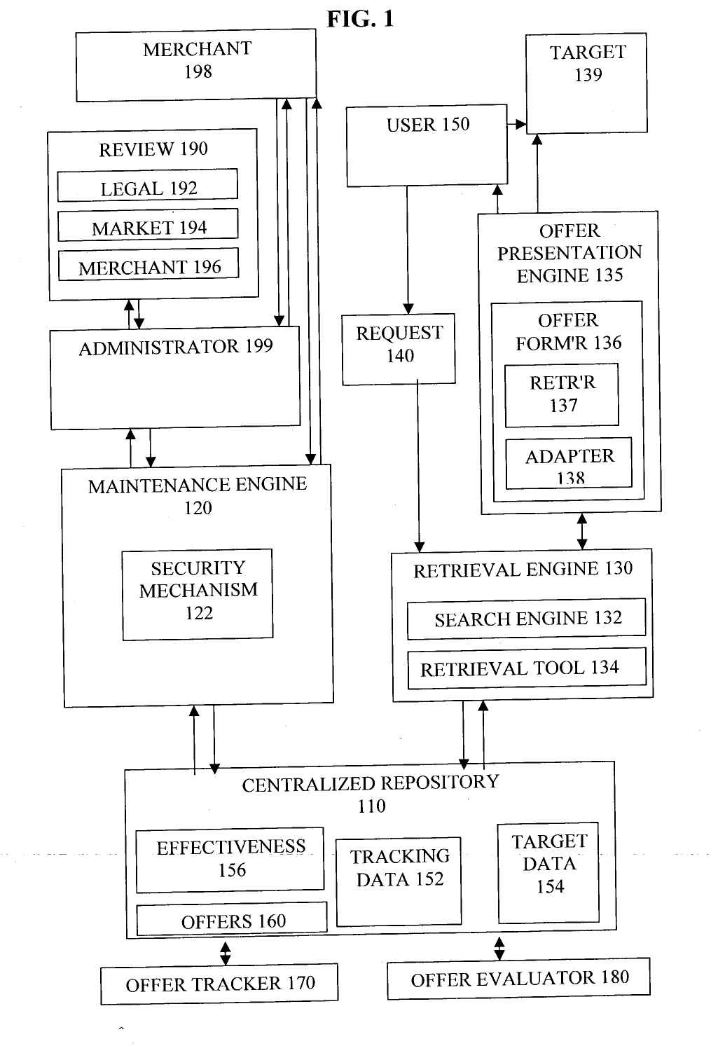

More particularly, FIG. 1 illustrates an exemplary system configured to administer an incentive offers utility. In accordance with an exemplary embodiment, the system includes a centralized repository 110 that is configured to store offers 160, tracking data 152, target data 154, and offer effectiveness data 156, which may include sensitivities to changes in offer content and/or context on offer value, likelihood of acceptance and/or composite effectiveness. Centralized repository 110 is in communication with a maintenance engine 120 that is configured to facilitate the updating and maintaining of offers 160 within the repository 110. In addition, maintenance engine 120 is in communication with offer tracker 107 and offer evaluator 108 as well as administrator 199 and merchant 198. Upon agreement between the merchant 198 and the administrator 199 regarding the content of an offer 160, administrator 199 cooperates with the maintenance engine 120 to accomplish the addition, modification, and/or deletion of offers 160 within repository 110. Upon the occurrence of one or more tracked event, offer tracker 107 stores tracking data 152 in repository 110. Offer evaluator 108 is configured to evaluate the effectiveness of changes on offer content and/or context on offer effectiveness and to store data 156 in repository 110. Maintenance engine 120 is configured to facilitate the addition, modification, and deletion of offers 160 based on instructions from administrator 199. Maintenance engine 120 is also configured to facilitate merchant's 198 directly searching and viewing offers 160 in repository 110.

Repository 110 is also in communication with retrieval engine 130, which is configured to facilitate finding and retrieving offers 160. Retrieval engine 130 is also in communication with offer presentation engine 135, which is configured to facilitate configuring and presenting offers to offeree 139. Retrieval engine 130 is in communication with user 150 and is configured to receive request 140 from user 150 for the retrieval of conforming offers 160. Request 140 may comprise search and retrieval instructions that may be configured by user 150. It should be noted that request 140 may include definitions indicating which offer parameters are to be sought and which parameters are to be retrieved. In response to request 140, retrieval engine 130 seeks the desired offers 160 via the user selected parameters and returns the parameters desired by the user. As discussed above, the user specification of offer parameters to be returned may be expressed as an instruction to return only a specified set of parameters or alternatively may be expressed as an instruction to return at least a specified set of parameters or may be expressed in any other form commonly known in the art. It should be noted that the user 150 may or may not be the offeree 139. In the event that the user 150 is not the offeree, the user 150 may present the offer to the offeree 139 or alternatively, offer presentation engine 135 may present the offer directly to the offeree 139.

In an exemplary embodiment, as shown in FIG. 1, offer presentation engine 135 comprises offer formulator 136, which is configured to retrieve appropriate data and to formulate offers based on such data in order to achieve one or more predefined goals. Accordingly, offer formulator 136 comprises an information retriever 137 and an offer adapter 138. Information retriever 137 cooperates with retrieval engine 130 to acquire identity information regarding target 139, and based on the identity information, acquires additional information 154 regarding attributes of target 139. In addition, information retriever 137 cooperates with retrieval engine 130 to acquire offer effectiveness data 156 from repository 110.

Based on target data 154 and offer effectiveness data 156, offer adapter 138 may formulate one or more appropriate offers (e.g., offer content and context) that are configured to accomplish one or more predefines goals considering the specific attributes of target 139. Exemplary goals may include formulating tests to evaluate sensitivities of offer effectiveness characteristics (e.g., offer value, offer likelihood of acceptance, composite probability-discounted offer value, NPV, and the like) to changes in offer content and/or context. Accordingly, offer adapter 138 may be configured to recognize the occurrence of one or more specific sets of target attributes and to formulate appropriate offers to exploit those circumstances (e.g., to maintain effective experimental controls, to minimize variability, to improve statistical significance, and/or to employ experimentation techniques such as Teguchi experimentation methods).

Other exemplary goals may be to maximize the effectiveness of specific offers in terms of their likely ability to generate profit for the offeror. Accordingly, offer adapter may be configured to predict an offer effectiveness parameter (such as value, NPV, likelihood of acceptance, probability-discounted value, and the like) based on various components of offer content and context as well as target attributes. In an exemplary embodiment, offer adapter may be configured to also consider external economic factors (e.g., consumer confidence, unemployment rates, prevailing interest rates, consumer price index, currency exchange rates, and the like) and to adapt offers accordingly.

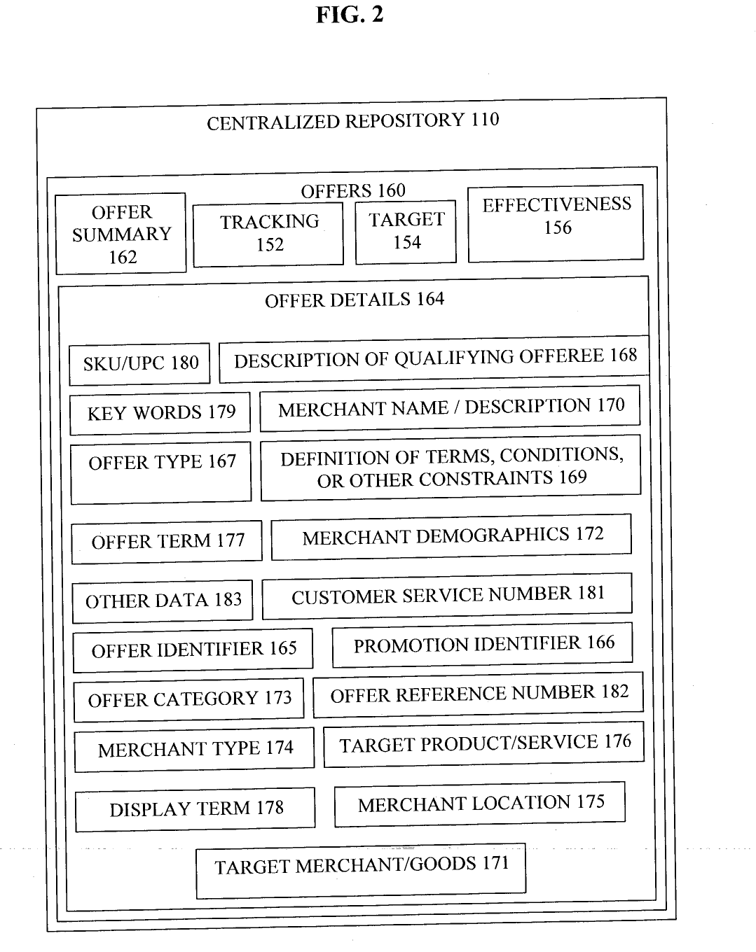

FIG. 2 illustrates an exemplary centralized repository 110. Each of the offers 160 in the repository 110 may include an offer summary 162 and a set of offer details 164. In addition, repository may include tracking data 152, target data 154, and offer effectiveness data 156. Repository or database 110 may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. The repository 110 may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database 110 according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

The system, which may be embodied in the form of a computer system, may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access Sequel Server, Oracle, MySQL, Intervase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

In general, the offer details 164 define who (e.g., the target consumer) performs what act (e.g., use or agree to purchase specific goods or services) within what time (e.g., during the offer period) and at what location (e.g., at a specified merchant) in order to receive what incentive. Specifically, offer details 164 may include an offer identifier 165, an offer promotion identifier 166 (e.g., identification of a specific marketing campaign or promotion), an offer type 167 (e.g., the method of presentation, fulfillment, or redemption), a description of qualifying offerees 168, and definitions of terms, conditions or other constraints 169. Additional details may include a merchant name and/or description 170, trademarks and/or service marks relating to the target merchant or the target goods 171, merchant demographics 172 (e.g., name, address, telephone number, facsimile number, internet address, email address), offer category 173 (e.g., industry, retail, dining, shopping), offer sub-category (e.g., product, merchant), merchant type 174 (e.g., single-location, chain), geographic location 175 (e.g., country, region, state, city, neighborhood, longitude, latitude, intersection, street address, zip code), target product or service 176, offers term 177 (e.g., start date/time, end date/time), display term 178 (e.g., display start date/time, display end date/time), key word(s) 179, SKU/UPC information 180, customer service telephone number 181, and an offer reference number 182. The offer details may further include any other data that would be helpful in identifying and characterizing offers to be sought by an offeror or an offeree and to be presented to that offeree 183.

The system is a dynamically searchable offer database 110 directly maintained by business partners 198 and accessible by clients 150. The database 110 includes data for online offers 160, such as its descriptive attributes 164 as well as the rules as to how the offer is to be managed and used. This representation is generic, because in one embodiment, there is nothing stored as to how the offer 160 will be used by the different application/business unit. This separation of content (the offer) 160 and context (how it will be used by some application) allows the offers 160 to be simplified and enables the platform to be integrated and standardized. This approach also allows the platform to be extended outside the entity, by enabling external third parties to use the database to house their own offers or as a source for displaying an individual entity's offers on its own web-sites.

In an exemplary embodiment, the database 110 is managed using a single application using either online and/or batch based processing. The process supports the key functions to add, change, and delete data for offers 160 or some discrete piece of an offer 160. Additionally, the process implements a workflow capability that allows customizable processes to be overlaid onto offers 160 for controlling how the offer 160 is created, refined, authorized, approved and published for use by consuming applications such as an offer presentation engine 135.

More specifically, in one embodiment, the offers 160 comprise a collection of attributes 164 detailing the content and make-up of each offer 160, an associated set of rules that identifies how and when the offer can/cannot be used 164, and a workflow that defines the process by which the offer may follow before it can be made available to an offeree. The context to be applied for the online offer is provided by the online process that will be requesting and accessing the offer data 160 from the system. In an exemplary embodiment, the data 160 is housed in a standard, consolidated and integrated database 110 that can be accessed by any approved user, including external third parties. The exemplary platform is designed to be process oriented instead of data (offer) oriented, thus making it open as to how it supports the corresponding process (beginning to end) and the data for each offer. This allows the offer 160 to be open in its definition and use, allowing an offer 160 to be used narrowly or very broadly.

In one embodiment, the platform may not provide presentation capabilities 135 for these online offers 160, so the data 160 is made available to requesters through a set of interfaces (API's). This interface describes how data may be requested (including searches and their corresponding variables) and how the results will be returned (using “databaskets”). One of the features included in how the data 160 can be requested is a search function. This search is performed dynamically based on one or more variables that may be defined 140 by the user 150. These online offers can be accessed by anyone with access to the database, including internal functions or those hosted by external third parties.

In an exemplary embodiment, the maintenance engine 120 is adapted to cooperate with an administrator 199 to create, modify, and delete offer summaries and offer details stored within the centralized offer repository 110. The maintenance engine 120 is also adapted to provide a security mechanism 122 adapted to authenticate a merchant 198 and/or administrator 199 before granting access to either. Accordingly, the security mechanism 122 is configured to limit access to a specific party or group of parties. Accordingly, the security mechanism 122 enables the maintenance engine 120 to safeguard the confidentiality of data 160 within the repository 110, preventing data 160 from being disclosed in an unauthorized or undesirable manner. The maintenance engine 120 is also configured to administer the review and approval of new offers 160 or offer modifications through various reviewing entities 190. In an alternative embodiment, the review may be administered by the administrator 199. These reviewing entities 190 may include one or more legal administrators 192, one or more marketing administrators 194, one or more designated merchants 196, and the like. Also, the maintenance engine 120 is configured to track the number of times a particular offer 160 or class of offers has been retrieved or requested. In addition, the maintenance engine 120 may be configured to export reports in accordance with a predetermined set of criteria (e.g., the occurrence of a predetermined event, such as the passage of a date).

The retrieval engine 130 is configured for retrieving offers 160 and may include both a search tool 132 and a retrieval tool 134. The retrieval engine 130 is adapted to send a request to the search tool 132 for the identification of an offer or set of offers 160. The retrieval tool 134 is configured to retrieve the identified offer or set of offers 160 or other information for formulation and presentation of an offer to the offeree by the retrieval engine 130. The search tool 132 provides the ability for users 150 to search for offers 160 using multiple search criteria (i.e., category, type, industry, etc.) within all elements of the database 110 that are deemed as searchable. Upon receipt of the request 140, the search tool 132 searches for the requested offer 160 and the retrieval tool 134 retrieves the summaries 162 and details 164 of the requested offer or offers 160. In an exemplary embodiment, the retrieval engine 130 is configured to generate additional reports 138 describing offers contained within the repository or the number of times an offer has been retrieved. Finally, the retrieval engine 130 may be configured to describe how data is retrieved or presented, and may also be configured to perform a search function responsive to several variables.

The presentation engine 135, which is in communication with the retrieval engine 130, facilitates the configuring and presenting of an offer 160 to an offeree, e.g., via a webpage. The presentation engine 135 receives data regarding an offer 160 from the retrieval tool 134 and also may receive data regarding the traits of the offeree and/or the context in which the offer is to be presented. Based on that information, or based on a predefined set of defaults if context or trait information is not available, the presentation engine 135 facilitates the configuring of the offer 160 based on the traits of offerees and the contexts in which the offer is to be presented.

The system contemplates the use of a well-defined interface, making the database 110 and maintenance function 120 accessible to anyone interested in presenting online offer data 160 to users. Consolidated processes and infrastructure supporting various online offers will reduce the resources and costs needed to create and maintain offers 160, while enabling the enterprise strategy of a single integrated online offers database that can be used with a company website. The system may also streamline the offeree experience by eliminating confusion that offerees experience today in viewing various online offers contained on a host website, positioning the company website as a destination site that provides continuous and ongoing value to offerees and driving increased on-line spending. The system also streamlines business processes across the enterprise for online offers by consolidating offeree communications by directing them to a single online offer source, establishing consistent branding of online offers across the company's applications and eliminating merchant confusion as individual online offer programs are sold-in to merchants with distinct/unique pricing implications and features. The system will also enable more offers 160 to be created and exposed to the consuming public.

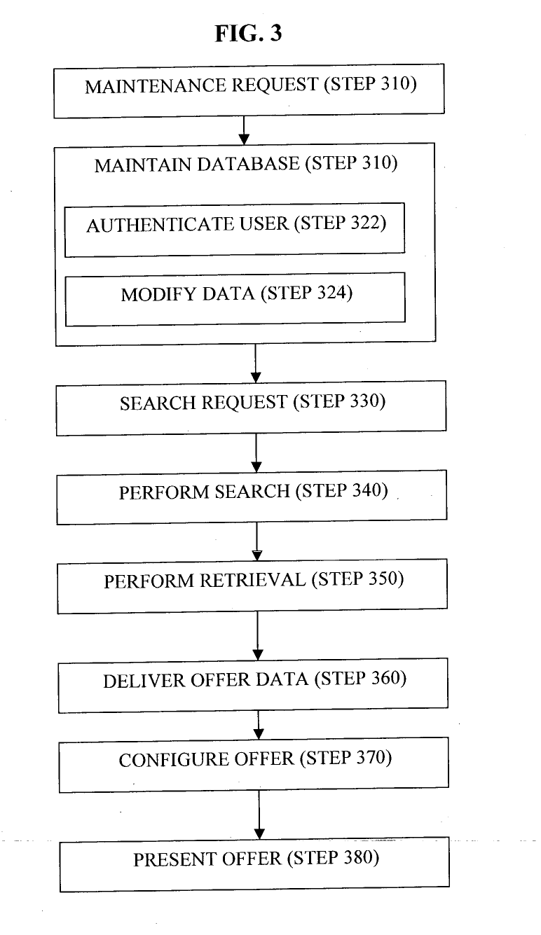

FIG. 3 depicts an exemplary method of administering an incentive offer storage and retrieval process. In accordance with the invention, a merchant 198 communicates a request to an administrator 199 to create, modify or delete an offer 160 or a portion of an offer (step 310). In an exemplary embodiment, the administrator 199 and the merchant 198 may negotiate and reach agreement on the content of the offer 160 to be implemented. In response, the administrator 199 causes the maintenance engine 120 to perform a database maintenance process (step 320). In an exemplary embodiment of the database maintenance process (step 320), the maintenance engine 120 causes a security mechanism 122 to authenticate the user, e.g., determining whether the user is authorized to initiate the action or whether the action is desirable to the system in accordance with a predetermined set of rules (step 322). If the security mechanism 122 authenticates the user and approves the desired action, the maintenance engine 120 accommodates the user's request and modifies the offer data accordingly (step 324). Once an offer 160 has been approved and implemented in the repository 110, it is available for review by the merchant 198. Accordingly, the maintenance engine 120 maintains the centralized repository of offer data 160, which comprises offer summaries 162 and offer details 164.

In accordance with the invention, a user 150 may also communicate a request 140 to the retrieval engine 130 seeking offers 160 bearing specified characteristics (e.g., offers for a specified service to be performed in a specified location or by a specified service provider) (step 330). In response to the user's 150 request 140, the retrieval engine 130 responds by activating its search tool 132 to retrieve offers bearing the desired characteristics (step 340). Once the search tool 132 has identified the conforming offers, the retrieval engine 130 activates its retrieval tool 134, which retrieves the conforming offer data 160, which may include offer summaries 162 and offer details 164 (step 350). Upon retrieval of the offer data 160, the retrieval engine 130 may communicate the offer data 160 to an offer presentation engine 135 or may deliver the information to an interface (API) (step 360). Upon receipt of the offer data 160 from the retrieval tool 134, the offer presentation engine 135 may configure the offer in accordance with rules imbedded in the offer 160 as well as offeree traits and the offer context or appropriate defaults (step 370). Finally, the offer presentation engine 135 presents the configured offer to the user 150, who may be an intended offeree or who may be a merchant interfacing with the intended offeree (step 380).

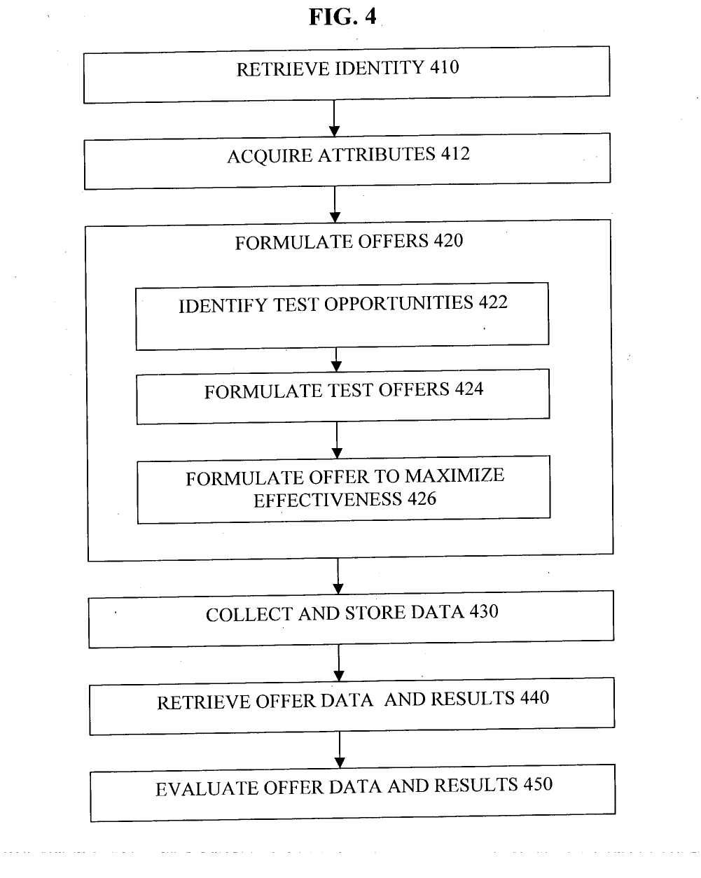

FIG. 4 depicts an exemplary method of adapting and evaluating offers. In an exemplary embodiment, information retriever retrieves identity information regarding target (step 410). Based on the identity information, information retriever acquires additional information regarding target's attributes and characteristics and may also acquire external information regarding pertinent economic factors (step 412). Then, based on the information collected by information retriever, and one or more predefined goals, offer adapter formulates one or more appropriate offers to be presented to target (step 420). In order to formulate the one or more offers, offer adapter may first determine whether the set of circumstances (e.g., the target's attributes, the economic environment) lends itself to performing an adequately controlled test (step 422). If the situation is appropriate, the offer adapter may formulate one or more offer configured to evaluate a sensitivity of the offer's effectiveness to a change in offer content and/or context (step 424). Alternatively, offer adapter may comply with a predefined goal by formulating an offer so as to maximize the probability-discounted NPV of the offer in view of the target's attributes and the environment (step 426).

In an exemplary embodiment, offer tracker collects and stores data regarding the occurrence and circumstances surrounding the formulation, presentation, evaluation, acceptance or abandonment of offers (step 430). In an exemplary embodiment, offer tracker receives a message from presentation engine each time a pertinent event occurs (step 432). In response, offer tracker sends a corresponding message to cause the event to be noted in centralized repository (step 434).

In another exemplary embodiment, offer evaluator retrieves data from centralized repository regarding content and context of presented offers as well as tracking data collected and stored by offer tracker (step 440). Then, based on changes in one or more aspect of offer content, offer context, target attributes, or external factors, and based on tracked events regarding the offers (such as requests for additional information, whether the offers were accepted or abandoned, and the like), offer evaluator may determine sensitivities to be used in formulating future offers and may store such sensitivities as well as aggregate probability data in centralized repository to be later accessed by information retriever (step 450).

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like. For a basic introduction of cryptography, please review a text written by Bruce Schneier which is entitled “Applied Cryptography: Protocols, Algorithms, And Source Code In C,” published by John Wiley & Sons (second edition, 1996). Other useful references include Gilbert Held's “Understanding Data Communications” (1996), Dilip Naik's “Internet standards and Protocols” (1998), and “Java 2 Complete” published by Sybex (1999).

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Communication between the parties to the system of the present invention is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The merchant, administrator, user, offeree and any other participant may represent individual people, entities, computers, systems, or business. Although labeled as a merchant or company, the entity may represent other types of institutions, such as credit card companies, card sponsoring companies, banks, or third party issuers under contract with financial institutions. It is further noted that other participants may be involved in some phases of the transaction, such as an intermediary settlement institution, but these participants are not shown.

Each participant is equipped with a computing system to facilitate online communication. The parties may have a computing unit in the form of a personal computer, although other types of computing units may be used including laptops, notebooks, hand held computers, set-top boxes, and the like. The parties may also have a computing unit implemented in the form of a computer-server, main frame computer, mini-computer, a PC server, a network set of computers, although other implementations are possible.

The computing units are connected with each other via a data communication network. The network is a public network and assumed to be insecure and open to eavesdroppers. In the illustrated implementation, the network is embodied as the internet. In this context, the computers may or may not be connected to the internet at all times. For instance, some of the computers may employ a modem to occasionally connect to the internet, whereas other computers might maintain a permanent connection to the internet. It is noted that the network may be implemented as other types of networks, such as an interactive television (ITV) network.

As a result, the system of the present invention provide a flexible structure, within which to adapt offers to specific contexts in response to variations in the traits of targeted offerees. The system also enables an user to perform tests with a significantly decreased amount of effort. Accordingly, the system may enable users to improve the targeting of customers, providing effective campaign management control and improving conversion rates.

The system also allows different offer package databases to display offers on different parts or pages of a website, while tracking the rate of offer acceptance for particular offer package databases. Accordingly, the system provides offerors a flexible, yet controlled, environment in which to conduct real-time testing across identified cell levers (e.g., customer segment, product set, page type, and creative strategy). As a result, users may identify correlations between the levers and offers, and may implementing identified correlations to effectively increase realized value. The results of these tests will help refine the qualification criteria, improve real-time minors, and improve the presentation of offers. The parametric offer evaluator will additionally provide timely and insightful learning that could be leveraged across other channels (e.g., offline).

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. For example, the steps recited in any of the method or process descriptions may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

What is claimed is:

1. A system for facilitating the administration of incentive offers comprising:
a centralized repository,
a maintenance engine in communication with the centralized repository for facilitating the maintenance of the repository,
a retrieval engine in communication with the centralized repository for facilitating the identification and retrieval of an offer,
said retrieval engine comprising an offer formulator having an information retriever and an offer adapter,
said centralized repository being configured to store a plurality of offers.

2. A system as in claim 1, said information retriever configured to retrieve attributes of a target.

3. A system as in claim 1, said information configured to retrieve information regarding content and context of an offer.

4. A system as in claim 1, said offer adapter configured to adapt content of an offer in based at least in part on one or more attribute of a target.

5. A system as in claim 1, said offer adapter configured to adapt context of an offer in based at least in part on one or more attribute of a target.

6. A system as in claim 1, said offer adapter configured to predict an effectiveness of an offer.

7. A system as in claim 6, said effectiveness based at least in part on a predicted value of said offer.

8. A system as in claim 6, said effectiveness based at least in part on a predicted probability of acceptance of said offer.

9. A system as in claim 6, said effectiveness based at least in part on a probability-discounted value of said offer.

10. A system as in claim 6, said offer adapter configured to adapt content of an offer so as to improve said effectiveness of said offer.

11. A system as in claim 6, said offer adapter configured to adapt context of an offer so as to improve said effectiveness of said offer.

12. A system as in claim 6, said offer adapter configured to effect a change in content of an offer so as to determine a sensitivity of said effectiveness to a change in content.

13. A system as in claim 6, said offer adapter configured to effect a change in context of an offer so as to determine a sensitivity of said effectiveness to a change in context.

14. A system as in claim 1, further comprising an event tracker.

15. A system as in claim 14, said event tracker configured to track attributes of an offer, said attributes including content of said offer.

16. A system as in claim 14, said event tracker configured to track attributes of an offer, said attributes including a product code associated with said offer.

17. A system as in claim 14, said event tracker configured to track attributes of an offer, said attributes including context of said offer.

18. A system as in claim 17, said context comprising an identity of a campaign associated with said offer.

19. A system as in claim 17, said context comprising a time associated with said offer.

20. A system as in claim 17, said context comprising a path associated with said offer.

21. A system as in claim 14, said offer communicated to a target, said event tracker configured to track attributes of said target.

22. A system as in claim 14, said offer communicated to a target, said event tracker configured to track whether said target accepted said offer.

23. A system as in claim 14, said offer communicated to a target, said event tracker configured to track attributes of said offer, said event tracker configured to track whether said target accepted said offer, said system further comprising an offer evaluator, said offer evaluator configured to determine an effectiveness of said offer.

24. A system as in claim 1, further comprising an offer evaluator.

25. A system as in claim 1, said offer evaluator configured to facilitate determining an effectiveness of an offer.

26. A method of facilitating the administration of an incentive offer storage and retrieval process comprising the steps of:
providing a centralized repository, a maintenance engine in communication with the centralized repository for facilitating the maintenance of the repository, and a retrieval engine in communication with the centralized repository for facilitating the identification and retrieval of an offer, said centralized repository being configured to store a plurality of offers; said retrieval engine comprising an offer formulator having an information retriever and an offer adapter;
retrieving information including attributes of a target, content and context of an offer, and predicting an effectiveness of said offer.
